(19) United States
(12) Patent Application Publication
(10) Pub. No.: US 2009/0030831 A1
(43) Pub. Date: Jan. 29, 2009

(54) METHOD FOR STRUCTURING, VALUATING AND TRADING SECURITIES RELATED TO THE PERFORMANCE OF ATHLETES

(76) Inventor: Mario El Sayeh, Stockholm (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 12/168,868

(22) Filed: Jul. 7, 2008

Related U.S. Application Data
(60) Provisional application No. 60/951,498, filed on Jul. 24, 2007.

(51) Int. Cl. G06Q 40/00

(52) U.S. Cl. 705/37

(57) ABSTRACT

The method is for structuring, valuating and trading securities. Athletes who have prior performances are evaluated. At a start of an evaluation period, a service provider determines initial values for securities based on the prior performance. The securities are traded in a market at a market price based on supply and demand. The service provider monitors performances of the athletes during the evaluation period. The service provider determines final values at an end of the evaluation period based on the performances and the final values are then paid to the investors.

### PRIOR APPLICATION

This application claims priority from U.S. provisional patent application No. 60/951,498, filed 24 Jul. 2007.

### TECHNICAL FIELD

The method relates to a method for structuring, valuating and trading securities related to the performance of athletes.

### BACKGROUND OF INVENTION

Many fans of sports events and athletes follow sports closely. However, some of the participation is relatively passive such as watching the sports events live as spectators or watching the events on television or computers. There is a need for a more active participation of the fans to further spur the interest of the fans in the sports.

### SUMMARY OF INVENTION

The method of the present invention provides a solution to the above-outlined problems. More particularly, the method of the present invention is for structuring, valuating and trading securities. Athletes who have prior performances are evaluated. At a start of an evaluation period, a service provider determines initial values for securities based on the prior performance the athletes. The initial values may be based on the earlier performance and other factors of the athletes. The securities are traded when the evaluation period, such as the season or series, starts in a market at a market price based on supply and demand. The service provider continuously monitors performances of the athletes during the evaluation period. The service provider determines final values of the securities at an end of the evaluation period based on the performances. The investors are compensated according to the final values of the securities at the end of the evaluation period.

### BRIEF DESCRIPTION OF DRAWINGS

FIG. 1 is a schematic flow diagram of the method of the present invention.

### DETAILED DESCRIPTION

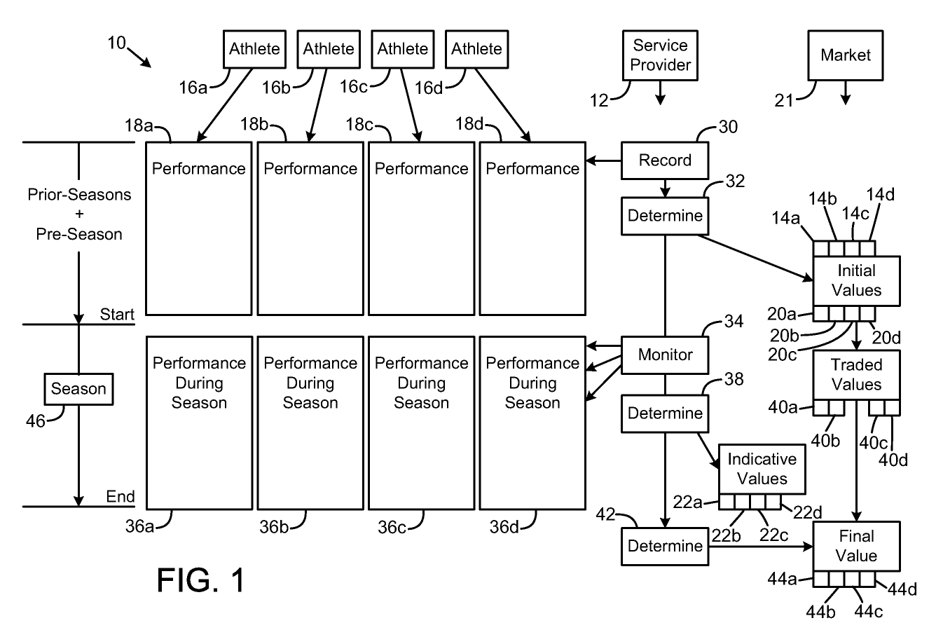

With reference to FIG. 1, the method 10 of the present invention relates to the structure, valuation and trade of securities that are based on the performance of athletes. More particularly, a service provider 12 determines initial values for securities related to each athlete based on the performance during prior evaluation periods and the pre-evaluation period. The initial values may also be based on a subjective evaluation by the service provider of the particular situation of the athletes. The athletes may be active in soccer, tennis, track and field or any other sports. For example, a first athlete 16a may be a high performing soccer player while a second athlete 16b, a third athlete 16c and a fourth athlete 16d are lower performing athletes in descending order so that a fourth athlete 16d is the lowest performer of all four athletes 16a-16d. Accordingly, the service provider 12 may record in a recording step 30 the prior performance 18a of the first athlete 16a during prior evaluation periods and during the pre-evaluation period. The service provider 12 then determines in a determining step 32 an initial value or price 14a for a security 20a associated with the athlete 16a based on the prior performance 18a and a subjective valuation of future performance. Similarly, the service provider 12 records and determines the initial values or prices 14b-14d of securities 20b-20d for the athletes 16b-16d based on the performances 18b-18d. The service provider 12 may therefore assign the initial price 14a to the security 20a for athlete 16a that is higher than the initial prices 14a-14d that are assigned to securities 20b-20d for athletes 16b-16d, respectively, in descending order. This means the first initial value 14a is higher than the second initial value 14b that is higher than the third initial value 14c that is higher than the fourth initial value 14d. Preferably, the initial values are determined by the service provider 12 prior to the start of an evaluation period 46 such as a sports season or event/tournament or any other period.

The initial prices/values 14a-14d of the athletes 16a-16d may be based on the number of goals, assists, shoots on goal, hits, winning games and other actions that enhances the performances 18a-18d. Of course, the athletes 16a-16d may lose points by, for example, losing games, causing penalty kicks, taking penalties or making mistakes that enables the opposing team to score. For example, each score may give two points while each goal assist gives one point. Two points may be deducted for each penalty of the athlete. Any suitable weighing of past performances may be used.

The securities 20a-20d may then be purchased at the initial values 14a-14d by the general public prior to the start of the evaluation period 46 such as the soccer season. All the money invested into the system may be put into a bank account until the money is paid back at the end of the evaluation period, as described below. The service provider 12 then continuously monitors in a monitoring step 34 the performances 36a-36d of each athlete 16a-16d during the evaluation period to determine in a determining step 38 the indicative values 22a-22d of the securities 20a-20d for each athlete 16a-16d. The indicative values may follow a formula of performance factors. The indicative values during the evaluation period may to a certain extent depend upon the initial values assigned to the athletes. The initial values have a greater effect on the indicative values in the beginning of the evaluation period and have virtually no effect towards the end of the evaluation period. The initial values have no effect on the indicative values after the last game of the evaluation period and the indicative value is then partly dependent upon the athlete's performance during the evaluation period and the amount paid back to the investors is based on the athlete's performance during the evaluation period. Preferably, this is a zero-sum game so that the indicative value may depend upon what the athlete has performed during the evaluation period relative to what other athletes have performed during the same evaluation period and dependent upon the number of securities issued. In this way, the indicative value has the greatest impact in the beginning of the evaluation period but no or insignificant impact after the last game of the evaluation period. Preferably, the indicative values are identical to the final values at the end of the evaluation period. Any suitable formula may be used to calculate the indicative value. An example of a suitable formula is shown below:

$$indicative\_value = ( \frac{sp + \frac{y - x}{y} \times ip}{sp\_all + \frac{y - x}{y} \times ip\_all} ) \times ip\_all$$

For example, the performances of the athletes may be converted to values of sub-performances such as the number of goals may be weighed at two points for each goal while assists are weighed at one point per assist. Warnings and other negative values may also be weighed and deducted from the accumulated value for each athlete.
sp=points that relate to an athlete's accumulated performances during a season
sp_all=the sum of sp_a−sp_d multiplied with the number of securities that exists for each, that is the sum (sp_a*number of securities for all a+ . . . +sp_d*number of securities for d,
ip=the initial value for the athlete,
ip_all=the congregated initial values for all the securities which is equivalent to the sum received by the service provider at the start of the evaluation period,
y=the total number of games/events during the evaluation period, and
x=the number of completed games/events during the evaluation period.

Sp may increase exponentially for each athlete which in turn also affects the indicative value exponentially. The indicative values may be calculated on an exponential value model so that the indicative value increases exponentially based on increased or improved performance. In this way, the indicative values 22a-22d for each athlete is iterated and changed continuously as the evaluation period progresses for each event occurred. The indicative values 22a-22d indicate what the securities 20a-20d should be worth when traded in a market 21. They are also intended to reflect the value of the athletes transformed from their performances and to some extent their initial values. As indicated above, the athletes 16a-16d may gain points by scoring, assisting, shoot on goal, hits, win games and other actions that enhances the performance. Again, the athletes 16a-16d may lose points by, for example, causing penalty kicks, taking penalties or making mistakes that enables the opposing team to score. The service provider 12 keeps track of the performances 36a-36d of each athlete 16a-16d and adjusts the indicative values 22a-22d accordingly and on an iterative basis as new events occur.

An important aspect of the method 10 of the present invention is that the market price or traded values 40a-40d are determined by the current supply and demand in the market place 21 for the traded securities 20a-20d. The trade values may be lower or higher than the initial values 14a-14d and the indicative values 22a-22d. This means the indicative values 22a-22d may not exactly follow the changes of the traded values 40a-40d for the securities 20a-20d. For example, if an athlete is expected to outperform the indicative value the traded value will exceed the indicative value. Preferably, the securities may be traded electronically over the Internet by visiting a web page of the service provider 12 or a partner of the service provider and, preferably, a transaction fee is charged for each trade.

The securities 20a-20d may be traded for the duration of the evaluation period 46 so the life time of each security is preferably limited to the evaluation period 46. Of course, the life time of the securities may be extended over several evaluation periods if desired or be shorter than a season or series. Any suitable life time may be used.

At the end of the evaluation period 46, the service provider 12 determines in a determining step 42 the final values 44a-44d for each security 20a-20d. The final values 44a-44d are the amounts that are paid to the investors of the securities 20a-20d and the final values are, preferably, strictly dependent upon final indicative values (22a-22d) or final values (44a-44d) that exist at the end of the evaluation period for each athlete 16a-16d. When the final values 44a-44d are paid out to the investors, the securities 20a-20d that mature are removed from the market 21 and are no longer available for trading. The traded values 40a-40d of the securities 20a-20d during the evaluation period 46 are therefore determined by the expectation of what the final values 44a-44d for each athlete will be.

The service provider 12 may charge a transaction fee when the securities 20a-20d are traded in the market 21. The service provider may also charge a management fee based on the clients' account possession. The method is preferably a zero sum game for all the investors but not necessarily for each investor so that all the invested money is returned to the investors. Preferably, the final values 44a-44d for the securities 20a-20d depend on the performances 36a-36d of athletes 16a-16d during the evaluation period 46 and are probably different from the initial values 14a-14d. The service provider may also return any interest earned on the money invested during the evaluation period to the investors. Of course, the service provider may keep the interest earned as compensation for providing the service.

While the present invention has been described in accordance with preferred compositions and embodiments, it is to be understood that certain substitutions and alterations may be made thereto without departing from the spirit and scope of the following claims.

1. A method for structuring, valuing and trading securities, comprising:
providing athletes having prior performances;
at a start of an evaluation period, a service provider determining initial values for securities based on the prior performance;
the securities being traded in a market at a market price based on supply and demand;
the service provider monitoring performances of the athletes during the evaluation period and determining indicative values; and
the service provider determining final values of the securities at an end of the evaluation period based on the performances.

2. The method according to claim 1 wherein the method further comprises the service provider charging a transaction fee when the securities are bought or sold.

3. The method according to claim 1 wherein the method further comprises the service provider continuously monitoring in a monitoring step the performances during the evaluation period.

4. The method according to claim 3 wherein the method further comprises the service provider recording in a recording step prior performances of the athletes prior to the start of the evaluation period.

5. The method according to claim 1 wherein the method further comprises the service provider determining in a determining step indicative values of the securities.

6. The method according to claim 5 wherein the method further comprises the performances being based on a number of goals scored by the athletes.

7. The method according to claim 1 wherein the method further comprises continually revaluing the indicative values of the securities for all the athletes.
